(19) United States
(12) Patent Application Publication
(10) Pub. No.: US 2026/0037280 A1
(43) Pub. Date: Feb. 5, 2026

(54) UTILIZING GENERATIVE ARTIFICIAL INTELLIGENCE (AI) WITHIN THE CONTEXT OF COLLABORATIVE WALLPAPER AS COMMUNICATION PLATFORM

(71) Applicant: Samsung Electronics Co., Ltd., Suwon-si (KR)

(72) Inventors: Jamar Alexander Bromley, Brooklyn, NY (US); Anthony James Mars, Park Ridge, NJ (US); Rachel Rose Miller, Millbrook, NY (US); Dan Gavie, Brooklyn, NY (US); Misael Rodriguez Valenzuela, Brooklyn, NY (US); Jeewon Lee, Mercer Island, WA (US); Myoung Woo Nam, Yongin-si (KR); Yeun Wook Lim, Daegu (KR)

(21) Appl. No.: 18/949,823

(22) Filed: Nov. 15, 2024

Related U.S. Application Data
(60) Provisional application No. 63/678,198, filed on Aug. 1, 2024.

(51) Int. Cl. G06F 9/451; H04L 51/216

(52) U.S. Cl. CPC G06F 9/451; H04L 51/216

(57) ABSTRACT

A method includes receiving a request to generate a collaborative wallpaper, the request identifying a plurality of users including the first user and a second user. The method further includes determining a background image for the collaborative wallpaper, determining, by at least one processor running an artificial intelligence/machine learning (AI/ML) model, at least one item of secondary content to be presented as part of the collaborative wallpaper, and generating the collaborative wallpaper comprising the background image and the at least one item of secondary content. The method also includes displaying a first instance of the collaborative wallpaper and a user interface for receiving, at the first device, a contribution from the first user, responsive to receiving the first contribution from the first user, regenerating the first instance of the collaborative wallpaper, and displaying at the first device, the regenerated first instance of the collaborative wallpaper.

### CROSS-REFERENCE TO RELATED APPLICATIONS AND PRIORITY CLAIM

This application claims priority under 35 U.S.C. § 119 (e) to U.S. Provisional Patent Application No. 63/678,198 filed Aug. 1, 2024. This provisional patent application hereby incorporated by reference in its entirety.

### TECHNICAL FIELD

This disclosure relates generally to user interfaces and the use of artificial intelligence to extend the functionality of smartphones and other networked devices as communication platforms.

### BACKGROUND

The proliferation of artificial intelligence (AI) models as tools for intelligent sorting and searching of data, as well as for the generation of media presents a host of opportunities for extending the functionality of electronic devices. To date, the possibilities of AI-based tools have principally been explored in the contexts of improvements in search and indexing, and of generative text creation, with enhancing the functionality of electronic devices as platforms for communication or collaboration, or for improving user interfaces remaining unconsidered areas for further development.

Accordingly, harnessing AI to enhance the functionality of portable, networked electronic devices as platforms for communication and collaboration remains a source of technical challenges and opportunities for improvement in the art.

### SUMMARY

This disclosure relates to utilizing generative artificial intelligence (AI).

In a first embodiment, a method of collaboratively generating an interface, includes, at a first device associated with a first user, receiving a request to generate a collaborative wallpaper, the request identifying a plurality of users including the first user and a second user. The method further includes determining a background image for the collaborative wallpaper, determining, by at least one processor running an artificial intelligence/machine learning (AI/ML) model, at least one item of secondary content to be presented as part of the collaborative wallpaper, and generating the collaborative wallpaper comprising the background image and the at least one item of secondary content. The method also includes displaying, at the first device, a first instance of the collaborative wallpaper and a user interface for receiving, at the first device, a contribution from the first user, receiving, at the first device, a first contribution from the first user, responsive to receiving the first contribution from the first user, regenerating the first instance of the collaborative wallpaper, and displaying at the first device, the regenerated first instance of the collaborative wallpaper.

In a second embodiment, an electronic device includes a memory, a display and at least one processor. The at least one processor is configured to receive a request to generate a collaborative wallpaper, the request identifying a plurality of users including a first user and a second user, determine a background image for the collaborative wallpaper, determine, by running an artificial intelligence/machine learning (AI/ML) model, at least one item of secondary content to be presented as part of the collaborative wallpaper, generate the collaborative wallpaper comprising the background image and the at least one item of secondary content, and display, at the display, a first instance of the collaborative wallpaper and a user interface for receiving a contribution from the first user. The processor can be further configured to receive a first contribution from the first user, responsive to receiving the first contribution from the first user, regenerate the first instance of the collaborative wallpaper and display the regenerated first instance of the collaborative wallpaper.

In a third embodiment, a non-transitory computer-readable medium comprises instructions, that when executed by at least one processor, cause an electronic device to receive a request to generate a collaborative wallpaper, the request identifying a plurality of users including a first user and a second user, determine a background image for the collaborative wallpaper, determine, by running an artificial intelligence/machine learning (AI/ML) model by the at least one processor, at least one item of secondary content to be presented as part of the collaborative wallpaper, and generate the collaborative wallpaper comprising the background image and the at least one item of secondary content. When executed by the processor, the instructions cause the electronic device to display, at the display, a first instance of the collaborative wallpaper and a user interface for receiving a contribution from the first user, receive a first contribution from the first user, responsive to receiving the first contribution from the first user, regenerate the first instance of the collaborative wallpaper, and display the regenerated first instance of the collaborative wallpaper.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IOT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIGS. 2A-2C illustrate examples of a user interface which includes a collaborative wallpaper and collaborative editing of same according to various embodiments of this disclosure;

FIGS. 3A and 3B illustrate example operations for generating a collaborative wallpaper and determining a background image for same according to this disclosure; and

FIG. 4 illustrates operations of an example method for generating a collaborative wallpaper according to this disclosure.

### DETAILED DESCRIPTION

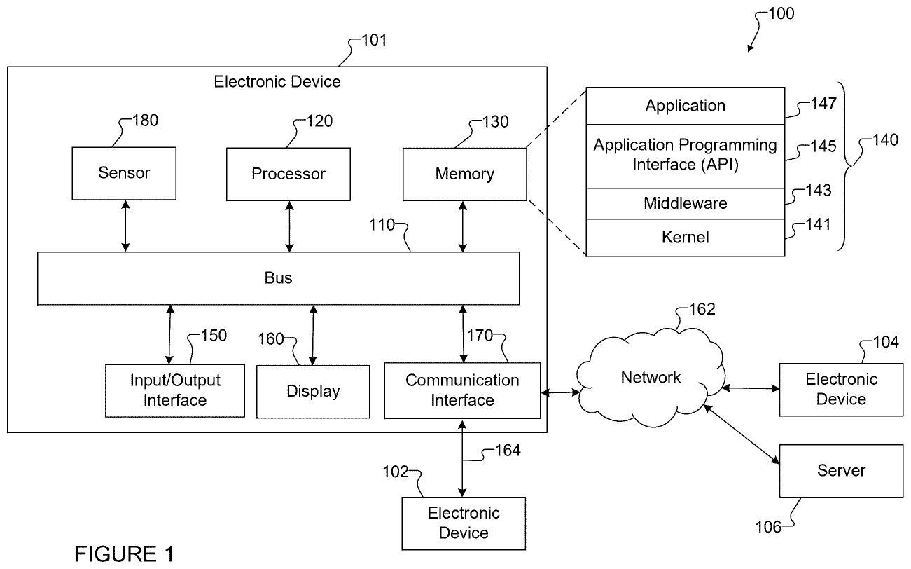

FIGS. 1 through 4, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, the proliferation of artificial intelligence (AI) models as tools for intelligent sorting and searching of data, as well as for the generation of media presents a host of opportunities for extending the functionality of electronic devices. To date, the possibilities of AI-based tools have principally been explored in the contexts of improvements in search and indexing, and of generative text creation, with enhancing the functionality of electronic devices as platforms for communication or collaboration, or for improving user interfaces remaining unconsidered areas for further development.

Accordingly, harnessing AI to enhance the functionality of portable, networked electronic devices as platforms for communication and collaboration remains a source of technical challenges and opportunities for improvement in the art.

This disclosure provides examples of apparatus, method and computer-executable program code for extending the functionality of networked devices as tools for communication and collaboration by utilizing generative artificial intelligence (AI) within the context of a collaborative wallpaper.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU) optimized for implementing artificial neural networks (ANNs) or other AI/ML models, or a neural processing unit (NPU). The processor 120 is able to perform control on at least one of the other components of the electronic device 101 and/or perform an operation or data processing relating to communication or other functions. As described below, the processor 120 may perform one or more functions related to communication and collaboration by utilizing generative artificial intelligence (AI) within the context of a collaborative wallpaper.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform communication and collaboration by utilizing generative artificial intelligence (AI) within the context of a collaborative wallpaper. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high-definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 include cameras or other imaging sensors, which may be used to capture images of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to communication and collaboration by utilizing generative artificial intelligence (AI) within the context of a collaborative wallpaper.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

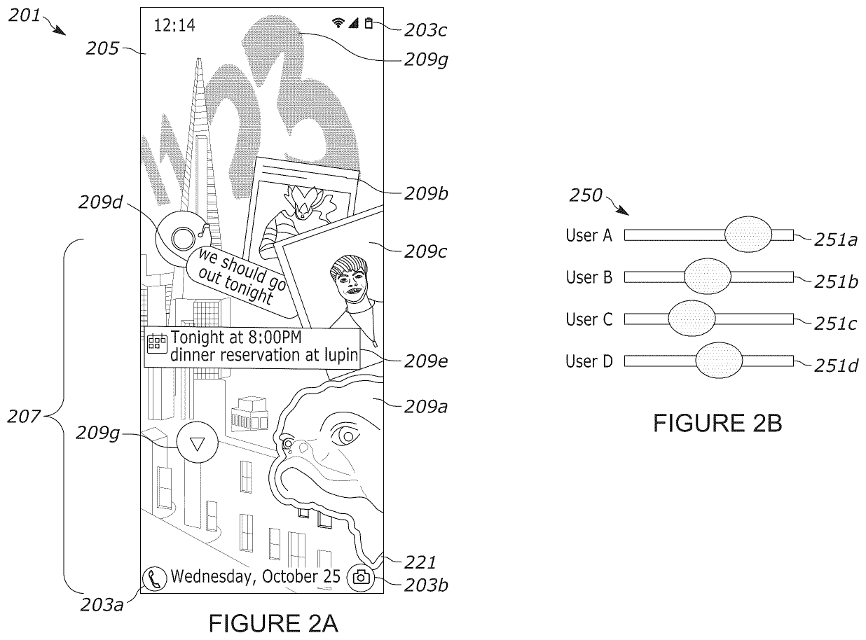

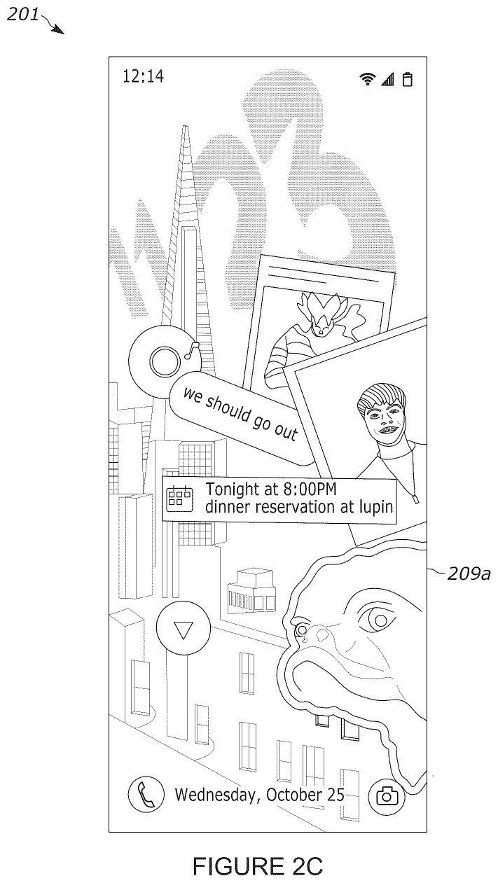

FIGS. 2A through 2C illustrate aspects of a collaborative wallpaper, including a wallpaper for a user interface, and methods for generating and communicatively collaborating to generate collaborative wallpapers according to this disclosure. For consistency and convenience of cross-reference, elements common to more than one of FIGS. 2A-2C are numbered similarly.

Referring to the illustrative example of FIG. 2A, an example user interface 201 comprising a plurality of icons and widgets, is shown in the figure. Example user interface 201 can be presented on a display (for example, display 160 in FIG. 1) of a suitably configured device (for example, device 101 in FIG. 1). While in this example, user interface 201 is presented as a “lock screen” of a smartphone, embodiments according to the present disclosure are not so limited.

User interface 201 includes, without limitation, an icon for opening a phone application 203a, an icon for opening a camera application 203b, and a clock/network status widget 203c, which shows a current time of 11:23, and when touched, can open up a settings application.

User interface 201 further comprises a collaborative wallpaper 205, which comprises a background image 207, which in this case, comprises a partial view of the San Franciso skyline, and a plurality of items of secondary content, including, without limitation, a cropped image of a dog 209a, a plurality of images 209b and 209c, a plurality of items of textual content 209d and 209e, an icon for opening an audio playback application 209f, and a stylized instance 209g of clock widget presented as a projected shadow in the space above background image 207. In some embodiments, the items of secondary of content can be drawn from content on a single device or associated with a single user. Additionally, or alternatively, the items of secondary content of collaborative wallpaper can be drawn from data stored at a plurality of devices or associated with a plurality of users. For example, background image 207 may be an image on an image gallery of photos taken by a first user (“User A”). The cropped image of a dog 209a may be an image taken by a fourth user (“User D”) of their dog, and by the same token, items of textual content 209d and 209e may have been posted or taken from devices associated with second and third users (“User B” and “User C”).

According to various embodiments of this disclosure, the selection, pre-processing and arrangement of the background image 207 and items of secondary content (for example, items 209a-209g) of collaborative wallpaper 205 of user interface 201 can be performed programmatically to provide an arrangement of elements which are selected and presented in a way that is not only useful and resonant to a single user or socially connected set of users, but also individually tunable. In this way, user interface 201 not only provides a useful user interface for individual users, but also provides a mechanism for collaboration and individual customization of instances of user interface 201 across devices.

Referring to the illustrative example of FIG. 2B, a second user interface 250 for individually tuning the relative influence of each user's contribution is shown. As shown in FIG. 2B, second user interface 250 comprises a plurality of sliders (251a-251d) by which the relative influence of each user associated with the background image and items of secondary content in collaborative wallpaper 205. Consistent with embodiments according to the present disclosure leveraging AI tools to select and arrange the elements of collaborative wallpaper 205, each individual slider of plurality of sliders 251a-251d controls “influence” as an operative parameter, wherein the parameters of “influence” can be automatically tuned by the processor generating collaborative wallpaper 205. For example, by decrementing the value of slider 251d associated with the “influence” of User D, the size of the secondary item of content 109a (User D's dog) is reduced in at least one instance of collaborative wallpaper 205, as shown in FIG. 2C.

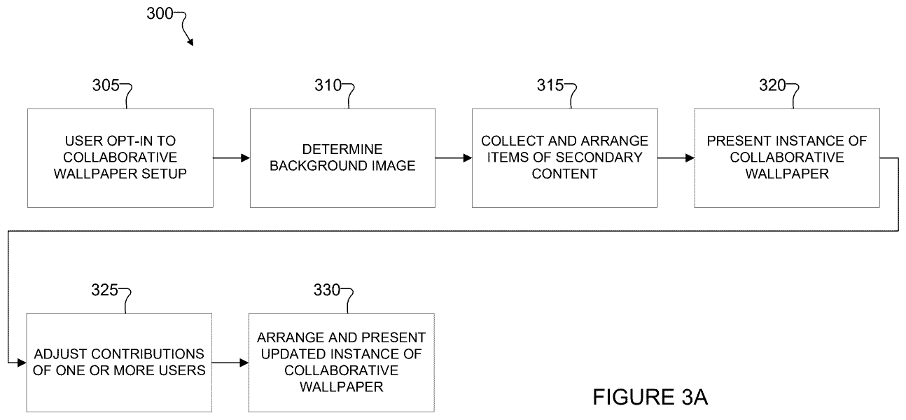

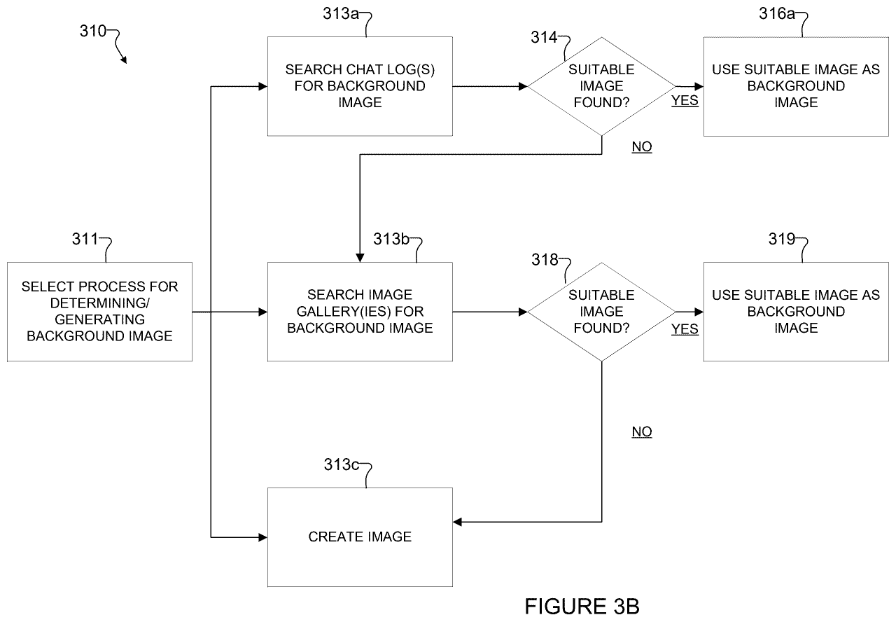

FIG. 3A illustrates an example of a high-level architecture 300 for generating a collaborative wallpaper (for example, wallpaper 205) according to embodiments of this disclosure. The operations described with reference to FIG. 3A can, in some embodiments, be performed by one or more processors at a single device (for example, a smartphone embodying the architecture of device 1010 in FIG. 1) or by processors embodied on a plurality of devices (for example, multiple smartphones, or combinations of smartphones and accessory devices, such as smartwatches or tablets).

Referring to the illustrative example of FIG. 3A, at block 305, the process of collaboratively generating and editing a collaborative wallpaper can begin by obtaining data indicating which users wish to opt-in to the process of providing data and inputs for a collaborative wallpaper project. In some embodiments, block 305 may be performed by circulating a message in a messaging application to potential participants inviting them to participate, and polling for their permission to provide data for the collaborative wallpaper. In some embodiments, the opt-in process can be performed as an in-app process of another application (for example, an extended reality (XR) application, or multi-player game). As part of the opt-in process, each of the polled users can, in some embodiments, specify conditions on the data on their devices which may be used for generating the collaborative wallpaper. For example, while a first user may grant permission to use the contents of her text messages and stored camera images, a second user may, for privacy reasons, opt to only permit access to his stored camera images.

At block 310, the background image (for example, background image 207 in FIG. 2A) is determined by one or more of processors of the devices associated with users who opted-in to participate in the creation of a collaborative wallpaper at block 305. As described in greater detail with respect to FIG. 3B of this disclosure, the determination of a background image can, in some embodiments, be performed as a three-stage process to find, or in the alternative, generate an image which satisfies one or more criteria. The one or more criteria can include, without limitation, a source limitation (for example, that the image was taken with the device's camera or a camera known to be of suitably equivalent resolution. An image quality criterion, for example, that the image satisfies clarity and contrast criteria. A subject matter criterion (for example, that an image contains a face of one or more of the users who have opted in to creating a collaborative wallpaper). Additionally, the one or more criteria can include a resonance/reaction criteria, wherein an image is selected based on the responses to the image itself or an associated conversation.

At block 315, the one or more processors apply one or more AI-based filters to identify a predetermined number of items of secondary content for inclusion in the collaborative wallpaper. Additionally, at block 315, the items of secondary content are pre-processed, and arranged to in an initial instance of the collaborative wallpaper. For example, pre-processing can include cropping or stylizing either the background image or items of secondary content. For example, and with reference to the example of FIG. 2, pre-processing and stylizing can include cropping background material from images (for example, content surrounding the dog in secondary item 209a, or drawing a mask in the blue-sky areas of background image 207 to create space for secondary item 209. Stylizing at block 315 can further include scaling background image 207 and the plurality of secondary items, and determining whether to add frames, and if so, the size and color of such frames (for example, frame 221 in FIG. 2A) to enhance contrast or satisfy other compositional criteria.

In this way, the participants who have opted in to creating a collaborative wallpaper can be spared the work associated with manual search and review of the many images stored in text conversation and photo albums on their devices. Depending on the embodiments, the secondary elements of the collaborative wallpaper can be selected by identifying a plurality of content types (i.e., to avoid a static wallpaper, and instead include a variety of types of content, including icons, widgets or functionalities of applications, such as the stylized version of the clock app presented as secondary item 209g in FIG. 1.

Further, at block 315, once selected and pre-processed, the background image and items of secondary content are arranged to create a first instance of the background wallpaper. According to some embodiments, a spatial template comprising a dynamic arrangement of basic shapes is created, for example, by using a generative AI drawing tool, and composition of the collaborative wallpaper is created in layers, starting with the background image 207 as the bottom image, and secondary items of content applied in successive layers over the background image at locations and sizes corresponding to the geometric shapes of the spatial template. In this way, a dynamic presentation of content with varying angles and engaging asymmetries can be realized from the raw material of content on the user's devices. At block 315, the locations, sizes, colors or other parameters of one or more elements of the collaborative wallpaper may be refined to satisfy one or more compositional criteria (for example, ensuring that a user's face appear unobstructed in the middle of the wallpaper), or locating items of secondary content at suitably peripheral locations within the composition of the collaborative wallpaper.

At block 320, one or more instances of the collaborative wallpaper generated at block 315 are presented. In some embodiments, an instance of the wallpaper is presented as an image in a text message, along with an instruction advising the viewer that they can further personalize and edit the instance of the collaborative wallpaper presented through a user interface of their device.

At block 325, the one or more users can edit the instance of the collaborative wallpaper presented at their device. According to some embodiments, the collaborative wallpaper can be edited through an image editing application, which gives the user control over the size, shape, placement and appearance of elements of the collaborative wallpaper. In some embodiments, an editing user interface (for example, user interface 250 in FIG. 2B) is presented, which allows the user to modify the appearance of the collaborative wallpaper according to one or more qualitative parameters (for example, “influence”) as shown in FIG. 2B, and generative AI, in combination with one or more parameter filters, generates a revised image conforming to the compositional criteria. The revised collaborative wallpaper generated at block 325 may be saved, so that users can, after multiple iterations of editing and tuning the contributions of users, revert back to a preferred version of the collaborative wallpaper.

At block 330, one or more instances of the collaborative wallpaper are re-generated based on the adjustments received at block 325 and presented to users. As is likely apparent from the figure, blocks 320 through 330 can be iterated multiple times, turning the creation of the collaborative wallpaper into a collaborative exchange between the users whose data is embodied in the composition of the wallpaper.

FIG. 3B illustrates operations of an example process (for example, the process of block 310 in FIG. 3A) for determining, and where appropriate, background images (for example, background image 207) and items of secondary content for a collaborative wallpaper according to embodiments of this disclosure.

Referring to the illustrative example of FIG. 3B, at block 311, one or more platforms implementing the architecture 300 of FIG. 3A determines a source for the background image from among: a.) images associated with a messaging application on one or more devices associated with the one or more users who have opted into participating in generating a collaborative wallpaper (i.e., proceeding directly to block 313a); b.) images in one or more photo galleries of the users who have opted into participating in generating a collaborative wallpaper (i.e., proceeding directly to block 313b); or c.) using generative AI to create a suitable background image (i.e., proceeding directly to block 313c). According to some embodiments, to save computational resources and ensure variety in the end product, the choice of source of background image may be performed randomly. In some embodiments, the choice of the source for the background image may be performed in response to a user prompt. Alternatively, and as described in greater detail with reference FIG. 3B, the choice for the source background image may be performed according to predefined logic.

At block 313a, an AI search tool reviews messages associated with images involving one or more of the opted-in participants to generating the collaborative wallpaper to find candidate background images which not only satisfy image-specific criteria (for example, resolution, contrast, recognized face(s) of opted-in participants), but are also associated with messaging conversations containing features which the AI search tool has been trained to recognize as indicative of eliciting a strong and favorable response among the participants to generating the collaborative wallpaper. Examples of features associated with an image resonating with one or more users can include, without limitation: a.) typographical features, such as exclamation points, or the use of all caps or “camel caps” in messages associated with the image; b.) use of emojis or digital annotation of images; c.) lexicographical features, such as misspellings or repeated letters (for example, “soooooo funnnnny” in text associated with the images; and d.) use of idiomatic words, or words strongly correlated with sarcasm or humor in text associated with the image. As noted elsewhere, the operations described in this figure for selecting a background image can also be used to select items of secondary content. Thus, messages or other items of content in which the aforementioned features are located may also be good candidates for items of secondary content to be included in a collaborative wallpaper.

At block 314, a determination is performed as to whether the AI-powered search conducted at block 313a has identified an image suitable for use as the background image. If a suitable image has been found, then operation proceeds to block 316a and the remainder of the collaborative wallpaper is constructed as described with reference to FIG. 3A.

If, at block 314, no suitable image has been found at block 313a, then operation proceeds to block 313b, wherein a second AI-powered search for an image in an image gallery of the open or more opted-in participants to generating the collaborative wallpaper is performed. The second AI-powered search, can, in certain embodiments search for features which correspond to image quality and image suitability. Examples of such features include, without limitation, features correlative with strong compositional layout, such as symmetry or regions of contrast mapping to basic shapes, such as triangles. Further examples of features which may be sought out in the AI-powered search at block 314 include, strong color contrast in the image, objects identified as desirable scenery (for example, colorful trees, surf, tall buildings), and one or more recognized user(s) faces.

At block 318, a determination is performed as to whether the AI-powered search conducted at block 313b has determined an image suitable for use as the background image of the collaborative wallpaper. If yes, then operation proceeds to block 319, and the suitable image is used as the background image, and the rest of the collaborative wallpaper is constructed, for example, as described in FIG. 3A.

If no suitable image is found at block 313b, then operation proceeds to block 313c, wherein an image is generated using a text-based generative AI tool. In certain embodiments, a user is provided with a fillable field in which the text-based prompt can be entered, either by typing, or through a voice-to-text application. A slider or other control dictating the level of realism or artistic agency the generative AI tool has over the generated image. For example, at a low level of agency, the generative AI tool may be limited to generating images that strive to replicate photographs, whereas, at a higher set level of agency, the generative AI tool may be allowed to produce an image as a hand-drawn sketch or according to a different artistic style. Additionally, or alternatively, the image generated at block 313c may be generated from descriptors of features found during the AI-powered searches at blocks 313a and 313b. For example, where the available images on a user's device suffer from a common defect (for example, poor image quality due to a damaged or dirty camera), but contained detectable features (for example, multiple instances of a home city skyline, or multiple themes, such as sunsets), the detected features can, in some embodiments, be repurposed as elements of a prompt to be provided to the generative AI tool at block 313c.

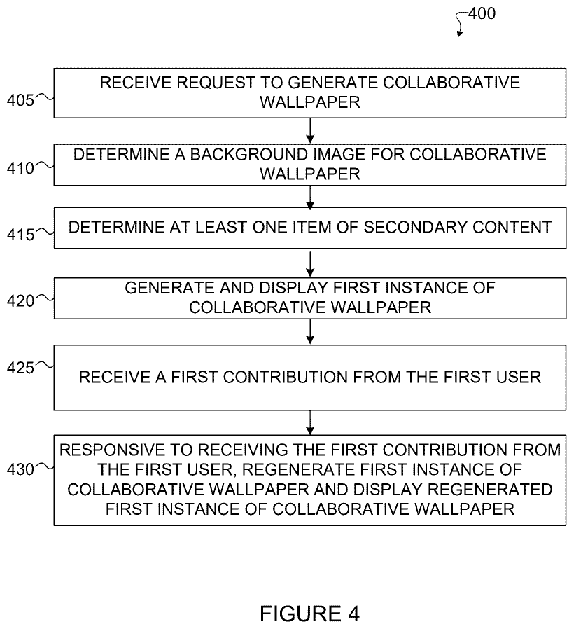

FIG. 4 illustrates operations of an example method 400 for generating a collaborative wallpaper (for example, collaborative wallpaper 205 in FIG. 2A) according to various embodiments of this disclosure.

Referring to the illustrative example of FIG. 4, at operation 405, a request to generate a collaborative wallpaper is received at one or more processors of a first device. According to various embodiments, the request to generate a collaborative wallpaper may be received as part of an operation initiating generation of a collaborative wallpaper and identifying users to opt-in to participating in and making their data available for generation of a collaborative wallpaper, such as described with reference to block 305 in FIG. 3A.

At operation 410, a background image for the collaborative wallpaper is determined from images associated with devices of users who opted in to creating the collaborative wallpaper at operation 405. According to some embodiments, the determination of the background image (for example, background image 207 in FIG. 2A) is determined by choosing an image (for example, as described with reference to FIG. 3B) from at least one of: a.) images in messages between the participants to the collaborative wallpaper project; b.) images in one or more image galleries of devices associated with the participants to the collaborative wallpaper project; or c.) generated using a generative AI imaging tool using textual prompts provided by a user or from tags associated with features detected in images in one or more of the participants to the collaborative wallpaper project's device images.

At operation 415, at least one item of secondary content (for example, items 209a-209g in FIG. 2A) is determined. In certain embodiments, a predetermined number of items of secondary content are determined by applying the same or similar AI-assisted searches as are used to identify the background image.

At operation 420, a first instance of the collaborative wallpaper is generated and displayed at the first device. According to certain embodiments, generating the collaborative wallpaper may comprise using a generative AI drawing tool to generate a template composition, which is a dynamic arrangement of basic shapes, and then assembling the collaborative wallpaper in layers, with the items of content scaled and positioned based on the forms of the template composition. In this way, the user is spared the challenge and effort of scaling and arranging items of content to create an engaging presentation. After positioning the items of content based on the template composition, the items may be further rescaled, repositioned or adjusted (for example, by adding a border) to satisfy one or more formatting rules, such as contrast or size requirements, or requirements that certain content not be occluded by content in overlaying layers.

At operation 425, the first device receives a contribution from the first user. In this example, the first contribution can be, without limitation, an edit to the collaborative wallpaper generated and displayed at operation 420, wherein the edit is performed using image editing software. For example, at operation 425, the first user may make a contribution by adding an additional item of secondary content or modifying an existing item of secondary content (for example, by changing a border or color of the item). Additionally, or alternatively, the first contribution may be an input adjusting the “influence” of one of the participants in the collaborative wallpaper project, thereby tuning the prominence of one or more items of content in the first instance of the collaborative wallpaper, such as shown with reference to FIGS. 2B and 2C of this disclosure.

At operation 430, responsive to receiving the first contribution from the first user, the first regenerates the first instance of the collaborative wallpaper and displays same.

It should be noted that the functions shown in or described with respect to FIGS. 2 through 4 can be implemented in an electronic device 101, 102, 104, server 106, or other device(s) in any suitable manner. For example, at least some of the functions shown in or described with respect to FIGS. 2 through 4 can be implemented or supported using one or more software applications or other software instructions that are executed by the processor 120 of the electronic device 101, 102, 104, server 106, or other device(s). In other embodiments, at least some of the functions shown in or described with respect to FIGS. 2 through 4 can be implemented or supported using dedicated hardware components. In general, the functions shown in or described with respect to FIGS. 2 through 4 can be performed using any suitable hardware or any suitable combination of hardware and software/firmware instructions. Also, the functions shown in or described with respect to FIGS. 2 through 4 can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. A method of collaboratively generating an interface, comprising:
at a first device associated with a first user, receiving a request to generate a collaborative wallpaper, the request identifying a plurality of users including the first user and a second user;
determining a background image for the collaborative wallpaper;
determining, by at least one processor running an artificial intelligence/machine learning (AI/ML) model, at least one item of secondary content to be presented as part of the collaborative wallpaper;
generating the collaborative wallpaper comprising the background image and the at least one item of secondary content;
displaying, at the first device, a first instance of the collaborative wallpaper and a user interface for receiving, at the first device, a contribution from the first user;
receiving, at the first device, a first contribution from the first user;
responsive to receiving the first contribution from the first user, regenerating the first instance of the collaborative wallpaper; and
displaying at the first device, the regenerated first instance of the collaborative wallpaper.

2. The method of claim 1, further comprising:
sending the collaborative wallpaper to a second electronic device associated with the second user;
displaying, at the second electronic device, a second instance of the collaborative wallpaper and a user interface for receiving, at the second electronic device, a second contribution from the second user;
responsive to receiving the second contribution from the second user, displaying, at the first device, an updated first instance of the collaborative wallpaper and a second user interface for adjusting an influence of the second contribution in the updated first instance of the collaborative wallpaper;
receiving, at the first device, via the second user interface, an input adjusting the influence of the second contribution;
at the first device, generating a re-updated first instance of the collaborative wallpaper based on the received input adjusting the influence of the second contribution; and
displaying, at the first device, the re-updated first instance of the collaborative wallpaper,
wherein the re-updated first instance of the collaborative wallpaper appears different from the second instance of the collaborative wallpaper.

3. The method of claim 2, wherein the re-updated first instance of the collaborative wallpaper comprises part of at least one of a lock screen or a home screen on the first device.

4. The method of claim 1, wherein determining the background image for the collaborative wallpaper comprises:
performing an initial search of at least one of the first device or a second electronic device, by running a trained AI language model by the at least one processor, for images associated with text messages showing a significant reaction by at least one of the first user or the second user; and
in response to the initial search identifying an image associated with text messages showing the significant reaction by at least one of the first user or the second user, determining the image associated with the text messages showing the significant reaction by at least one of the first user or the second user to be the background image.

5. The method of claim 4, wherein performing the initial search for images associated with text messages showing the significant reaction comprises at least one of:
searching for text messages satisfying a typographical criterion;
searching for text messages satisfying spelling-related criteria;
searching for text messages satisfying intended meaning-related criteria; or
searching for text messages satisfying punctuation criteria.

6. The method of claim 4, further comprising:
in response to the initial search failing to identify an image associated with texts showing the significant reaction by at least one of the first user or the second user, performing at least one of:
a secondary search of at least one of the first device or the second electronic device, for an image satisfying at least one image criterion; or
generating an image from a text prompt; and
determining one of the images satisfying the at least one image criterion or the image generated from the text prompt to be the background image.

7. The method of claim 6, wherein the at least one image criterion comprises at least one of:
a symmetry criterion;
a threshold level of color contrast;
a threshold level of color saturation; or
a presence of at least one of the first or second users.

8. The method of claim 1, wherein the at least one item of secondary content comprises at least one of an icon, a photo, a video, a voice note, a haptic note, a generative AI image, a memo note, a calendar date, a link, or a graphic sticker.

9. An electronic device, comprising:
a memory;
a display; and
at least one processor configured to:
receive a request to generate a collaborative wallpaper, the request identifying a plurality of users including a first user and a second user;
determine a background image for the collaborative wallpaper;
determine, by running an artificial intelligence/machine learning (AI/ML) model, at least one item of secondary content to be presented as part of the collaborative wallpaper;
generate the collaborative wallpaper comprising the background image and the at least one item of secondary content;
display, at the display, a first instance of the collaborative wallpaper and a user interface for receiving a contribution from the first user;
receive a first contribution from the first user;
responsive to receiving the first contribution from the first user, regenerate the first instance of the collaborative wallpaper; and
display the regenerated first instance of the collaborative wallpaper.

10. The electronic device of claim 9, wherein the at least one processor is further configured to:
send the collaborative wallpaper to a second electronic device associated with the second user;
cause the second electronic device to display a second instance of the collaborative wallpaper and a user interface for receiving, at the second electronic device, a second contribution from the second user;
responsive to receiving the second contribution from the second user, display an updated first instance of the collaborative wallpaper and a second user interface for adjusting an influence of the second contribution in the updated first instance of the collaborative wallpaper;
receive via the second user interface, an input adjusting the influence of the second contribution;
generate a re-updated first instance of the collaborative wallpaper based on the received input adjusting the influence of the second contribution; and
display the re-updated first instance of the collaborative wallpaper,
wherein the re-updated first instance of the collaborative wallpaper appears different from the second instance of the collaborative wallpaper.

11. The electronic device of claim 10, wherein the re-updated first instance of the collaborative wallpaper comprises part of at least one of a lock screen or a home screen on the electronic device.

12. The electronic device of claim 9, wherein, to determine the background image for the collaborative wallpaper, the at least one processor is further configured to:
perform an initial search of at least one of the electronic device or a second electronic device, by running a trained AI language model, for images associated with text messages showing a significant reaction by at least one of the first user or the second user; and
in response to the initial search identifying an image associated with text messages showing the significant reaction by at least one of the first user or the second user, determine the image associated with the text messages showing the significant reaction by at least one of the first user or the second user to be the background image.

13. The electronic device of claim 12, wherein, to perform the initial search for images associated with text messages showing the significant reaction, the at least one processor is further configured to perform at least one of:
a search for text messages satisfying a typographical criterion;
a search for text messages satisfying spelling-related criteria;
a search for text messages satisfying intended meaning-related criteria; or
a search for text messages satisfying punctuation criteria.

14. The electronic device of claim 12, wherein the at least one processor is further configured to:
in response to the initial search failing to identify an image associated with texts showing the significant reaction by at least one of the first user or the second user, perform at least one of:
a secondary search of at least one of the electronic device or the second electronic device, for an image satisfying at least one image criterion; or
a generation of an image from a text prompt; and
determine one of the images satisfying the at least one image criterion or the image generated from the text prompt to be the background image.

15. The electronic device of claim 14, wherein the at least one image criterion comprises at least one of:
a symmetry criterion;
a threshold level of color contrast;
a threshold level of color saturation; or
a presence of at least one of the first or second users.

16. The electronic device of claim 9, wherein the at least one item of secondary content comprises at least one of an icon, a photo, a video, a voice note, a haptic note, a generative AI image, a memo note, a calendar date, a link, or a graphic sticker.

17. A non-transitory computer-readable medium comprising instructions that when executed by at least one processor, cause an electronic device to:
receive a request to generate a collaborative wallpaper, the request identifying a plurality of users including a first user and a second user;
determine a background image for the collaborative wallpaper;
determine, by running an artificial intelligence/machine learning (AI/ML) model by the at least one processor, at least one item of secondary content to be presented as part of the collaborative wallpaper;
generate the collaborative wallpaper comprising the background image and the at least one item of secondary content;
display, at the display, a first instance of the collaborative wallpaper and a user interface for receiving a contribution from the first user;
receive a first contribution from the first user;
responsive to receiving the first contribution from the first user, regenerate the first instance of the collaborative wallpaper; and
display the regenerated first instance of the collaborative wallpaper.

18. The non-transitory computer-readable medium of claim 17, wherein the instructions, when executed by the at least one processor, further cause the electronic device to:
send the collaborative wallpaper to a second electronic device associated with the second user;
cause the second electronic device to display a second instance of the collaborative wallpaper and a user interface for receiving, at the second electronic device, a second contribution from the second user;
responsive to receiving the second contribution from the second user, display an updated first instance of the collaborative wallpaper and a second user interface for adjusting an influence of the second contribution in the updated first instance of the collaborative wallpaper;
receive via the second user interface, an input adjusting the influence of the second contribution;
generate a re-updated first instance of the collaborative wallpaper based on the received input adjusting the influence of the second contribution; and
display the re-updated first instance of the collaborative wallpaper,
wherein the re-updated first instance of the collaborative wallpaper appears different from the second instance of the collaborative wallpaper.

19. The non-transitory computer-readable medium of claim 17, wherein the instructions that when executed by the at least one processor cause the electronic device to determine the background image for the collaborative wallpaper further include instructions that when executed by the processor cause the electronic device to:
perform an initial search of at least one of the electronic device or a second electronic device, by running by the at least one processor, a trained AI language model, for images associated with text messages showing a significant reaction by at least one of the first user or the second user; and
in response to the initial search identifying an image associated with text messages showing the significant reaction by at least one of the first user or the second user, determine the image associated with the text messages showing the significant reaction by at least one of the first user or the second user to be the background image.

20. The non-transitory computer-readable medium of claim 19, wherein the instructions that when executed by the at least one processor cause the electronic device to perform the initial search for images associated with text messages showing the significant reaction further include instructions that when executed by the at least one processor cause the electronic device to perform at least one of:
a search for text messages satisfying a typographical criterion;
a search for text messages satisfying spelling-related criteria;
a search for text messages satisfying intended meaning-related criteria; or
a search for text messages satisfying punctuation criteria.
